(19) United States
(12) Patent Application Publication
(10) Pub. No.: US 2023/0034136 A1
(43) Pub. Date: Feb. 2, 2023

(54) SYSTEM AND METHOD FOR SCHEDULING COMMUNICATION WITHIN A DISTRIBUTED LEARNING AND DEPLOYMENT FRAMEWORK

(71) Applicant: Kabushiki Kaisha Toshiba, Tokyo (JP)

(72) Inventors: Theo CHOW, Bristol (GB); Aftab KHAN, Bristol (GB); Usman RAZA, Bristol (GB)

(73) Assignee: Kabushiki Kaisha Toshiba, Tokyo (JP)

(21) Appl. No.: 17/444,069

(22) Filed: Jul. 30, 2021

(51) Int. Cl. G06N 20/00; G06K 9/62; H04L 29/08

(52) U.S. Cl. CPC G06N 20/00; G06K 9/6215; G06K 9/623; G06K 9/6265; H04L 67/10

(57) ABSTRACT

A method for managing a deployment of a machine learning model in a system comprising a training node and an inference node, the method comprising: training, by the training node, the machine learning model; generating, by the training node, a first set of confidence scores; transmitting, by the training node to the inference node, the first set of confidence scores and a representation of the machine learning model; generating, by the inference node: inferences by inputting data obtained by the inference node into the machine learning model; and a second set of confidence scores comprising confidence scores associated with the inferences; determining, by the inference node, whether the first set of confidence scores and the second set of confidence scores are similar; and if not, transmitting, by the inference node, at least part of the data for training an updated machine learning model at the training node.

### TECHNICAL FIELD

The present disclosure relates to a method for managing a deployment of a machine learning model, a method of operating an inference node in a distributed machine learning deployment and a method of operating a training node in a distributed machine learning deployment.

### BACKGROUND

Embedded devices are electronic objects that are designed for a particular purpose and are typically used to control the physical operations of a machine or to monitor the performance of a machine. To be suitable for these purposes embedded devices must meet real-time performance constraints such as low power, small physical size and low manufacturing cost. As a result, embedded devices generally have low computing capabilities, limited memory, and low storage space.

Sensors are often attached to these embedded devices to collect data. Examples of sensors include a camera collecting images or an environmental sensor measuring carbon dioxide (CO₂) levels.

Machine learning relates to the training of a machine learning model by performing updates based on a set of training data. Machine learning can be applied to train neural networks. Neural Networks (NN) are computer systems inspired by the human brain. Neural Networks (NN) often comprise multiple interconnected nodes, where each node receives multiple inputs and provides a corresponding output (e.g. through a weighted sum). Connections between nodes are regulated by weights which are parameters that need to be optimised through model training.

The use of machine learning models to analyse sensor data is growing. In the past, sensor data collected by an embedded device had to be transmitted to another node that possessed greater computing power in order to be used with a machine learning model. Improved computational capabilities of embedded devices allows the embedded device to execute the machine learning model, thereby removing the need to communicate all of the raw data to another node. However over time the machine learning model deployed on the embedded device can become outdated and produce inaccurate inferences if the distribution of the raw data changes, as often happens over long-term deployments. For this reason there is a need to continually train the machine learning model used for inferences. This training cannot generally be conducted at the embedded device due to the constrained resources. As a result, training the machine learning model often takes place at a training node (e.g. a server).

This approach requires communication exchanges between the embedded device and the training node (e.g. communicating the updated machine learning models from the training node to the embedded device, and communicating new raw data to train the machine learning models from the embedded device to the training node). Previous approaches involve scheduling communications at fixed time intervals. However this approach lacks responsiveness and is associated with a high communication overhead. This can be particularly problematic for embedded devices as communicating is a power intensive activity.

In light of this there is a need for an improved way of managing the deployment of machine learning models in distributed systems, particularly when deployed on embedded devices.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a sensor-worker arrangement without model deployment;

FIG. 2A shows a distributed machine learning architecture according to an arrangement;

FIG. 2B shows a distributed machine learning architecture according to another arrangement;

FIG. 3 shows a fixed scheduling approach for managing communications in the system of FIG. 2B;

FIG. 4 shows a scheduling method for managing communication exchanges in a distributed machine learning deployment according to an arrangement;

FIG. 5 shows how the data sets are updated over time according to an arrangement.

FIG. 6 shows the performance of a distributed system using naïve scheduling to control data and model exchanges between the sensor and the worker;

FIG. 7 shows the performance of a distributed system using the scheduling method according to an arrangement;

FIG. 8 shows the performance of a distributed system using naïve scheduling to control data exchanges but with data restricted to the same amount as occurs when using the method according to an arrangement;

FIG. 9 shows a comparison of data transfer between the worker and the sensor when using the fixed interval (naïve) scheduler, a data restricted fixed interval (naïve) scheduler and a scheduler according to an arrangement;

FIG. 10 shows a comparison of the deployed model accuracy at the sensor when using no scheduling, the fixed interval (naïve) scheduler, a data restricted scheduler, and a scheduler according to an arrangement; and

FIG. 11 shows a node according to an arrangement.

### DETAILED DESCRIPTION

According to a first aspect there is provided a method for managing a deployment of a machine learning model in a system comprising a training node and an inference node. The method comprising: training, by the training node, the machine learning model based on a training data set; generating, by the training node, a first set of confidence scores comprising confidence scores associated with an output of the machine learning model when a first validation data set is inputted to the machine learning model; transmitting, by the training node to the inference node, the first set of confidence scores and a representation of the machine learning model; and receiving, by the inference node, the first set of confidence scores and the representation of the machine learning model. The method further comprising: generating, by the inference node: inferences by inputting data obtained by the inference node into the machine learning model; and a second set of confidence scores comprising confidence scores associated with the inferences; determining, by the inference node, whether the first set of confidence scores and the second set of confidence scores are similar; and in response to determining that the first set of confidence scores and the second set of confidence scores are not similar: transmitting, by the inference node to the training node, at least part of the data for training an updated machine learning model; receiving, by the training node, the at least part of the data; and in response to receiving the at least part of the data, adding, by the training node, the at least part of the data to the training data set.

In an embodiment the inference node is an embedded device.

In an embodiment the training node is a server.

In an embodiment the training node and the inference node communicate via a wireless connection.

In an embodiment the data is generated by the inference node.

In an embodiment the method further comprises: generating, by the inference node, a first cumulative distribution function based on the first set of confidence scores; and generating by the inference node, a second cumulative distribution function based on the second set of confidence scores, wherein: determining, by the inference node, whether the first set of confidence scores and the second set of confidence scores are similar further comprises: determining whether the first cumulative distribution function and the second cumulative distribution function are similar.

In an embodiment determining whether the first cumulative distribution function and the second cumulative distribution function are similar comprises: generating a measure of difference between the first cumulative distribution function and the second cumulative distribution function using a Kolmogorov-Smirnov (KS) test; and determining that the first cumulative distribution function and the second cumulative distribution function are not similar in response to determining that the measure of difference is greater than a first threshold.

In an embodiment the first threshold equals a sum of: a previous measure of difference generated using the Kolmogorov-Smirnov (KS) test and a first predetermined value. In an embodiment: θₛ>θₛ₋₁+β, where θₛ is a Kolmogorov-Smirnov (KS) test value generated when comparing the cumulative distribution function (CDF) of the received confidence values with the CDF of the confidence values generated from the test set, s, θₛ₋₁ is a Kolmogorov-Smirnov (KS) test value generated when comparing the cumulative distribution function (CDF) of the received confidence values associated with the previously received machine learning model with the CDF of the confidence values generated from the test set, s-1, i.e. the CDF associated with the previous machine learning model at the sensor; and β is a third threshold (optionally, between 0 and 1).

In an embodiment the method further comprises: determining, by the training node, whether the machine learning model has destabilised and re-stabilised after training the machine learning model; and in response to determining that the machine learning model has destabilised and re-stabilised: transmitting, by the training node to the inference node, the first set of confidence scores and the representation of the machine learning model.

In an embodiment training, by the training node, the machine learning model further comprises: training the machine learning model for a plurality of training iterations, wherein each iteration in the plurality of training iterations comprises updating parameters of the machine learning model. In this embodiment determining whether the machine learning model has destabilised further comprises: determining a mean absolute loss difference for the plurality of training iterations; and determining whether the mean absolute loss difference for the plurality of training iterations is greater than a second threshold.

In an embodiment the plurality of training iterations comprises 10 training iterations.

In an embodiment determining the mean absolute loss difference for the plurality of training iterations comprises: calculating a training loss and a validation loss for each of the plurality of training iterations; and the mean absolute loss difference for the plurality of training iterations is determined based on an average of the training loss minus the validation loss for each of the plurality of training iterations.

In an embodiment the training loss is calculated according to a difference between the machine learning model output and an observation when the training data set is an input; and the validation loss is calculated according to a difference between the machine learning model output and an observation when a second validation data set is an input.

In an embodiment the plurality of training iterations comprises a first set of training iterations and a second set of training iterations; determining the mean absolute loss difference for the plurality of training iterations comprises: determining a mean absolute loss difference for the first set of training iterations; determining whether the mean absolute loss difference for the first set of training iterations is greater than a second threshold; and determining whether the machine learning model has re-stabilised further comprises: determining a mean absolute loss difference for the second set of training iterations; calculating a standard deviation of: the mean absolute loss difference for the first set of training iterations and the mean absolute loss difference for the second set of training iterations; determining whether the standard deviation is less than a third threshold; and in response to determining that the standard deviation is less than the third threshold: calculating a line of best fit between the mean absolute loss difference for the first set of training iterations and the mean absolute loss difference for the second set of training iterations; and determining that the machine learning model has destabilised and restabilised recently if the gradient of the line of best fit is within a fourth threshold.

In an embodiment the fourth threshold is ±0.005.

In an embodiment determining the mean absolute loss difference for the plurality of training iterations comprises: determining a mean absolute loss difference for only the first set of training iterations.

In an embodiment training, by the training node, the machine learning model further comprises: training the machine learning model for a first time window comprising a first plurality of training iterations, wherein each iteration in the first plurality of training iterations comprises updating parameters of the machine learning model; and training the machine learning model for a second time window comprising a second plurality of training iterations, wherein each iteration in the second plurality of training iterations comprises updating parameters of the machine learning model; and determining whether the machine learning model has destabilised further comprises: determining a mean absolute loss difference for the first time window; and determining whether the mean absolute loss difference for the first time window is greater than a second threshold.

In an embodiment determining a mean absolute loss difference for the first time window comprises: calculating a training loss and a validation loss for each of the plurality of training iterations in the first time window; and the mean absolute loss difference for the first time window is determined based on an average of the training loss minus the validation loss for each of the plurality of training iterations in the first time window.

In an embodiment the method further comprises training, by the training node, the machine learning model based on a training data set comprising the at least part of the data in response to receiving the at least part of the data.

In an embodiment the method further comprises: adding, by the training node, a subset of the at least part of the data to a second validation data set.

In an embodiment the method further comprises: updating the first validation data set based on the updated training data set comprising the data.

In an embodiment the system is a Federated Learning system.

According to a second aspect there is provided a method of operating an inference node in a distributed machine learning deployment. The method comprising receiving a first set of confidence scores and a representation of a machine learning model; generating: inferences by inputting data obtained by the inference node into the machine learning model; and a second set of confidence scores comprising confidence scores associated with the inferences; determining whether the first set of confidence scores and the second set of confidence scores are similar; and in response to determining that the first set of confidence scores and the second set of confidence scores are not similar: transmitting, to a training node, at least part of the data for training an updated machine learning model.

In an embodiment the method is a computer-implemented method.

In an embodiment the method further comprises: generating a first cumulative distribution function based on the first set of confidence scores; generating a second cumulative distribution function based on the second set of confidence scores; and wherein: determining whether the first set of confidence scores and the second set of confidence scores are similar further comprises: determining whether the first cumulative distribution function and the second cumulative distribution function are similar.

In an embodiment the method further comprises determining whether the first cumulative distribution function and the second cumulative distribution function are similar comprises: generating a measure of difference between the first cumulative distribution function and the second cumulative distribution function using a Kolmogorov-Smirnov (KS) test; and determining that the first cumulative distribution function and the second cumulative distribution function are not similar in response to determining that the measure of difference is greater than a first threshold.

In an embodiment the first threshold equals a sum of: a previous measure of difference generated using the Kolmogorov-Smirnov (KS) test and a first predetermined value.

According to a third aspect there is provided a method of operating a training node in a distributed machine learning deployment, the method comprising: training a machine learning model based on a training data set; generating a first set of confidence scores comprising confidence scores associated with an output of the machine learning model when a first validation data set is inputted to the machine learning model; transmitting, to an inference node, the first set of confidence scores and a representation of the machine learning model; receiving the at least part of the data; and in response to receiving the at least part of the data, adding the at least part of the data to the training data set.

In an embodiment the method is a computer-implemented method.

In an embodiment the method further comprises determining whether the machine learning model has destabilised and re-stabilised after training the machine learning model; and the first set of confidence scores and the representation of the machine learning model are transmitted in response to determining that the machine learning model has destabilised and re-stabilised.

In an embodiment training the machine learning model further comprises: training the machine learning model for a plurality of training iterations, wherein each iteration in the plurality of training iterations comprises updating parameters of the machine learning model; and determining whether the machine learning model has destabilised further comprises: determining a mean absolute loss difference for the plurality of training iterations; and determining whether the mean absolute loss difference for the plurality of training iterations is greater than a second threshold.

In an embodiment determining the mean absolute loss difference for the plurality of training iterations comprises: calculating a training loss and a validation loss for each of the plurality of training iterations; and the mean absolute loss difference for the plurality of training iterations is determined based on an average of the training loss minus the validation loss for each of the plurality of training iterations.

In an embodiment the plurality of training iterations comprises a first set of training iterations and a second set of training iterations; determining the mean absolute loss difference for the plurality of training iterations comprises: determining a mean absolute loss difference for the first set of training iterations; determining whether the mean absolute loss difference for the first set of training iterations is greater than a second threshold; and determining whether the machine learning model has re-stabilised further comprises: determining a mean absolute loss difference for the second set of training iterations; calculating a standard deviation of: the mean absolute loss difference for the first set of training iterations and the mean absolute loss difference for the second set of training iterations; determining whether the standard deviation is less than a third threshold; and in response to determining that the standard deviation is less than the third threshold: calculating a line of best fit between the mean absolute loss difference for the first set of training iterations and the mean absolute loss difference for the second set of training iterations; and determining that the machine learning model has destabilised and destabilised recently if the gradient of the line of best fit is within a fourth threshold.

In an embodiment the method further comprises training the machine learning model based on a training data set comprising the at least part of the data in response to receiving the at least part of the data.

According to a fourth aspect there is provided a system for managing a deployment of a machine learning model, the system comprising a training node and an inference node wherein: the training node is configured to: train the machine learning model based on a training data set; generate a first set of confidence scores comprising confidence scores associated with an output of the machine learning model when a first validation data set is inputted to the machine learning model; and transmit, to the inference node, the first set of confidence scores and a representation of the machine learning model; and wherein the inference node is configured to: receive the first set of confidence scores and the representation of the machine learning model; generate inferences by inputting data obtained by the inference node into the machine learning model; and generate a second set of confidence scores comprising confidence scores associated with the inferences; determine whether the first set of confidence scores and the second set of confidence scores are similar; and in response to determining that the first set of confidence scores and the second set of confidence scores are not similar: transmit by the inference node to the training node, at least part of the data for training an updated machine learning model; wherein the training node is further configured to: receive the at least part of the data; and in response to receiving the at least part of the data, add the at least part of the data to the training data set.

In an embodiment the inference node is further configured to: generate a first cumulative distribution function based on the first set of confidence scores; and generate a second cumulative distribution function based on the second set of confidence scores, wherein: determining, by the inference node, whether the first set of confidence scores and the second set of confidence scores are similar further comprises: determining whether the first cumulative distribution function and the second cumulative distribution function are similar.

In an embodiment the inference node is configured to determine whether the first cumulative distribution function and the second cumulative distribution function are similar by: generating a measure of difference between the first cumulative distribution function and the second cumulative distribution function using a Kolmogorov-Smirnov (KS) test; and determining that the first cumulative distribution function and the second cumulative distribution function are not similar in response to determining that the measure of difference is greater than a first threshold.

In an embodiment the first threshold equals a sum of: a previous measure of difference generated using the Kolmogorov-Smirnov (KS) test and a first predetermined value.

In an embodiment the training mode is further configured to determine whether the machine learning model has destabilised and re-stabilised after training the machine learning model; and in response to determining that the machine learning model has destabilised and re-stabilised: transmit, to the inference node, the first set of confidence scores and the representation of the machine learning model.

In an embodiment the training node, when training the machine learning model is further configured to: train the machine learning model for a plurality of training iterations, wherein each iteration in the plurality of training iterations comprises updating parameters of the machine learning model; and determine a mean absolute loss difference for the plurality of training iterations; and determine whether the mean absolute loss difference for the plurality of training iterations is greater than a second threshold, when determining whether the machine learning model has destabilised.

In an embodiment, the training node is configured, when determining the mean absolute loss difference for the plurality of training iterations, to: calculate a training loss and a validation loss for each of the plurality of training iterations; and wherein the mean absolute loss difference for the plurality of training iterations is determined based on an average of the training loss minus the validation loss for each of the plurality of training iterations.

In an embodiment the plurality of training iterations comprises a first set of training iterations and a second set of training iterations; and the training node is configured, when determining the mean absolute loss difference for the plurality of training iterations, to: determine a mean absolute loss difference for the first set of training iterations; and determine whether the mean absolute loss difference for the first set of training iterations is greater than a second threshold; and wherein the training node is further configured, when determining whether the machine learning model has re-stabilised to: determine a mean absolute loss difference for the second set of training iterations; calculate a standard deviation of: the mean absolute loss difference for the first set of training iterations and the mean absolute loss difference for the second set of training iterations; determine whether the standard deviation is less than a third threshold; and in response to determining that the standard deviation is less than the third threshold: calculate a line of best fit between the mean absolute loss difference for the first set of training iterations and the mean absolute loss difference for the second set of training iterations; and determine that the machine learning model has destabilised and restabilised recently if the gradient of the line of best fit is within a fourth threshold.

In an embodiment the training node is further configured to: train the machine learning model based on a training data set comprising the at least part of the data in response to receiving the at least part of the data.

In an embodiment the training node is further configured to: add a subset of the at least part of the data to a second validation data set.

According to a fifth aspect there is provided and inference node configured to: receive a first set of confidence scores and a representation of a machine learning model; generate: inferences by inputting data obtained by the inference node into the machine learning model; and generate a second set of confidence scores comprising confidence scores associated with the inferences; determine whether the first set of confidence scores and the second set of confidence scores are similar; and in response to determining that the first set of confidence scores and the second set of confidence scores are not similar: transmit, to a training node, at least part of the data for training an updated machine learning model.

In an embodiment the inference node is further configured to: generate a first cumulative distribution function based on the first set of confidence scores; generate a second cumulative distribution function based on the second set of confidence scores; and determine whether the first cumulative distribution function and the second cumulative distribution function are similar, when determining whether the first set of confidence scores and the second set of confidence scores are similar.

In an embodiment the inference node is configured to: generate a measure of difference between the first cumulative distribution function and the second cumulative distribution function using a Kolmogorov-Smirnov (KS) test; and determine that the first cumulative distribution function and the second cumulative distribution function are not similar in response to determining that the measure of difference is greater than a first threshold; when determining whether the first cumulative distribution function and the second cumulative distribution function.

In an embodiment the first threshold equals a sum of: a previous measure of difference generated using the Kolmogorov-Smirnov (KS) test and a first predetermined value.

According to sixth aspect there is provided a training node configured to: train a machine learning model based on a training data set; generate a first set of confidence scores comprising confidence scores associated with an output of the machine learning model when a first validation data set is inputted to the machine learning model; transmit, to an inference node, the first set of confidence scores and a representation of the machine learning model; receive the at least part of the data; and in response to receiving the at least part of the data, adding the at least part of the data to the training data set.

In an embodiment the training node is further configured to determine whether the machine learning model has destabilised and re-stabilised after training the machine learning model; and transmit the first set of confidence scores and the representation of the machine learning model in response to determining that the machine learning model has destabilised and re-stabilised.

In an embodiment the training node is further configured, when training the machine learning model, to: train the machine learning model for a plurality of training iterations, wherein each iteration in the plurality of training iterations comprises updating parameters of the machine learning model; and wherein, when determining whether the machine learning model has destabilised, the training node is further configured to: determine a mean absolute loss difference for the plurality of training iterations; and determine whether the mean absolute loss difference for the plurality of training iterations is greater than a second threshold.

In an embodiment the training node is further configured to: determine the mean absolute loss difference for the plurality of training iterations, by: calculating a training loss and a validation loss for each of the plurality of training iterations; and wherein the mean absolute loss difference for the plurality of training iterations is determined based on an average of the training loss minus the validation loss for each of the plurality of training iterations.

In an embodiment the plurality of training iterations comprises a first set of training iterations and a second set of training iterations and the training node is configured, when determining the mean absolute loss difference for the plurality of training iterations, to: determine a mean absolute loss difference for the first set of training iterations; determine whether the mean absolute loss difference for the first set of training iterations is greater than a second threshold; and the training node is configured, when determining whether the machine learning model has re-stabilised to: determine a mean absolute loss difference for the second set of training iterations; calculate a standard deviation of: the mean absolute loss difference for the first set of training iterations and the mean absolute loss difference for the second set of training iterations; determine whether the standard deviation is less than a third threshold; and in response to determining that the standard deviation is less than the third threshold: calculate a line of best fit between the mean absolute loss difference for the first set of training iterations and the mean absolute loss difference for the second set of training iterations; and determine that the machine learning model has destabilised and destabilised recently if the gradient of the line of best fit is within a fourth threshold.

In an embodiment the training node is further configured to train the machine learning model based on a training data set comprising the at least part of the data in response to receiving the at least part of the data.

According to a seventh aspect there is provided a non-transitory computer-readable medium comprising computer program instructions suitable for execution by a processor, the instructions configured, when executed by the processor, to: receive a first set of confidence scores and a representation of a machine learning model; generate inferences by inputting data obtained by the inference node into the machine learning model; and generate a second set of confidence scores comprising confidence scores associated with the inferences; determine whether the first set of confidence scores and the second set of confidence scores are similar; and in response to determining that the first set of confidence scores and the second set of confidence scores are not similar: transmit, to a training node, at least part of the data for training an updated machine learning model.

According to an eighth aspect there is provided a non-transitory computer-readable medium comprising computer program instructions suitable for execution by a processor, the instructions configured, when executed by the processor, to: train a machine learning model based on a training data set; generate a first set of confidence scores comprising confidence scores associated with an output of the machine learning model when a first validation data set is inputted to the machine learning model; transmit, to an inference node, the first set of confidence scores and a representation of the machine learning model; receive the at least part of the data; and in response to receiving the at least part of the data, add the at least part of the data to the training data set.

The present application describes, amongst other things, methods for efficiently enabling embedded machine learning within a distributed deployment where inferences from the machine learning model are generated in a different device or system (e.g. at a different place) to where the machine learning model is trained. This is particularly applicable to embedded devices in Federated Learning (FL) systems.

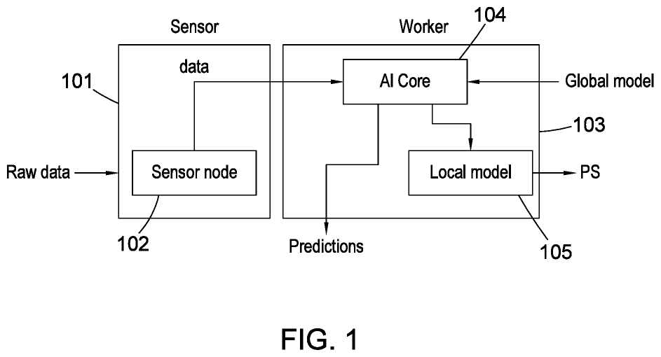

FIG. 1 shows a sensor-worker arrangement without model deployment. FIG. 1 shows part of a Federated Learning (FL) system. Federated Learning (FL) is a machine learning architecture in which training of the machine learning model is implemented across multiple devices within an overall system. In a typical Federated Learning (FL) deployment the parameters of the local machine learning model 105 are shared with a parameter server and aggregated, by the parameter server, with local machine learning models from other workers to form an updated global model. This global model is subsequently communicated to the worker nodes.

The Federated Learning (FL) system of FIG. 1 comprises a sensor 101 comprising a sensor node 102. The sensor 101 generates raw data through measurement or observation. The sensor 101 is communicatively coupled to a worker 103. The worker 103 comprises an Artificial Intelligence (AI) core 104 and a local model 105. The worker 103 is communicatively coupled to a parameter server (not shown), which stores a global machine learning model. The worker node 103 is configured to receive a global machine learning model, or parameters of the global machine learning model, from the parameter server (not shown).

The sensor 101 is configured to communicate data to the worker 103. The Artificial Intelligence (AI) core 104 generates inferences based on the global machine learning model and the data received from the sensor 101. The worker 103 also generates and updates a local machine learning model 105 based on the data received from the sensor 101. In this regard, at least some of the data sent from the sensor 101 to the worker 104 can be considered training data for training the machine learning model.

In the arrangement of FIG. 1 data collected by the sensor 101 has to be communicated to the worker 103 in order to generate predictions. Or in other words, only the worker 103 is able to generate predictions using the machine learning model. As a result, this approach results in a high communications overhead between the sensor 101 and the worker 103.

In an alternative example the worker 103 in FIG. 1 is in the form of a centralised (e.g. cloud) server. In this case data from the sensor 101 is transmitted the centralised server. The centralised server subsequently makes inferences based on the received data and trains the machine learning model at the centralised server. In this arrangement there is no communication to or from a parameter server as discussed in relation to the Federated Learning (FL) example. Nevertheless, as with the Federated Learning example, there is a large transmissions overhead associated with transmitting the data from the sensor to the centralised server for inference.

The increasingly advanced sensing and computing capabilities of embedded devices enable machine learning models to be implemented on the embedded devices themselves rather than relying on a separate worker node to process the data generated by the embedded devices. Consequently inferences from the machine learning model can be obtained closer to the endpoints where the data is collected. This arrangement reduces the amount of data that needs to be transmitted through public networks to the centralised server or worker node and preserves the privacy of users by avoiding the external sharing of sensor data. This is particularly advantageous given the growing number of Internet of Things (IoT) devices and applications that could make use of machine learning.

Deploying machine learning models on embedded devices is made possible by a number of factors. As discussed above, embedded devices are being manufactured with increased capability (e.g. larger storage space and higher processing speed) due to advances in manufacturing. As a result, some modern day embedded devices have the processing power to run machine learning models on the device and obtain inferences locally.

There have also been advances in the tools used to generate implementations of the machine learning models. For instance, modern tools such as Tensorflow™ Lite, makes deployment of machine learning models on embedded devices with lower computing capabilities or on mobile phones possible. These tools generate lightweight machine learning models that can be used for inference. These models use optimisation techniques such as quantisation and delegates to improve inference speed without sacrificing accuracy. This allows for fast inference on less computationally capable devices, such as sensors.

Consequently, it is now possible to deploy machine learning models on embedded devices. By deploying machine learning models on embedded devices, the raw data (e.g. sensor data) does not need to be transmitted from the sensor node for the purpose of inference. Instead a trained model can be deployed on the sensor node and inference can occur without additional raw data transmission.

This is advantageous, however over time the machine learning model deployed on the sensor node can become outdated. For example, due to changes in the environment in which the sensor node resides, the machine learning model could be making inferences on a data distribution that the model was never trained for. This may lead to a reduction in the accuracy of the machine learning model.

In light of this there is a need to ensure that the machine learning model deployed on the sensor node remains accurate over time in spite of any environmental changes in long-term deployments. In general, embedded devices do not possess the computational capability to both train a machine learning model and generate inferences from the machine learning model. As a result, raw data must be transmitted from the sensor node to a worker device in order to further train the machine learning model at the worker device. Once the machine learning model has been suitably trained by the worker device this model must be communicated to the node devices for subsequent use.

As this application discusses training in a federated learning scenario, the worker devices are described as being on the “edge” and as being “edge devices”. This reflects the Federated Learning scenario where local training is performed remotely from a central server which manages the update of a global model. Nevertheless, as discussed above with regard to FIG. 1, the worker device need not be an edge device in a Federated Learning scenario, but may be a central device that either updates a single model for a single sensor, or manages the updates of separate models or a global model across multiple sensors.

Furthermore, although the examples are described below with reference to “raw” data it is emphasised that the examples described below could be used with any source of data. This includes, for example, a source of pre-processed data. In addition, one or more processing steps (e.g. filtering) may be performed on the data prior to it being utilised in the methods described herein (e.g. prior to the data being added to the training set and/or prior to the data being input into the model for inference).

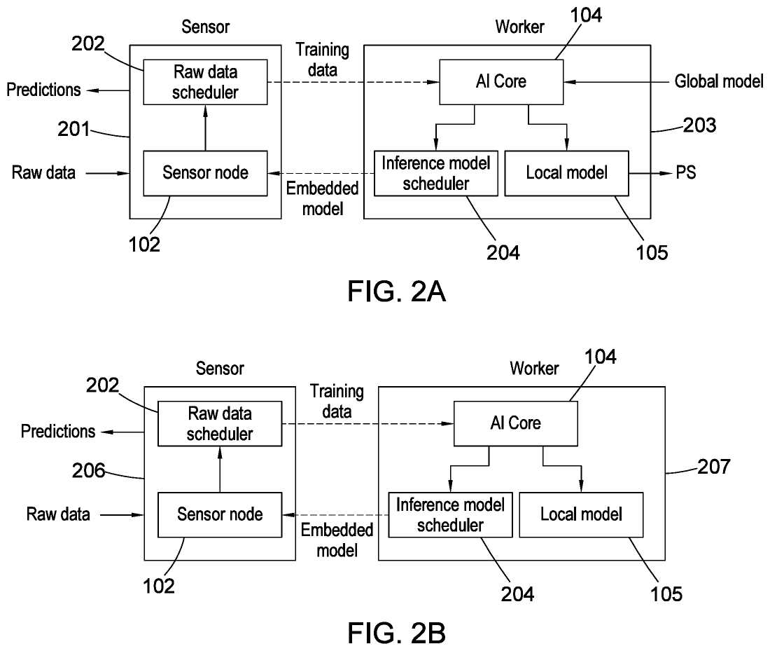

FIG. 2A shows a distributed machine learning architecture according to an arrangement. FIG. 2A shows architecture comprising a sensor 201 communicatively coupled to a worker 203. The sensor 201 comprises a sensor node 102 and a raw data scheduler 202. The sensor 201 receives raw data (e.g. through observation or measurement) and generates predictions (or inferences) based on the received raw data and a locally stored machine learning model (not shown). The raw data scheduler 202 is configured to transmit training data to the worker node 203. The training data is a subset of the raw data generated or received by the sensor 201.

The worker node 203 comprises an Artificial Intelligence Core (104), a local machine learning model 105, and an inference model scheduler 204. The inference model scheduler 204 is configured to transmit a machine learning model or parameters of the machine learning model to the sensor 201. Optionally, the inference model scheduler is configured to transmit an embedded machine learning model to the sensor 201. The embedded machine learning model is a machine learning model optimised, as discussed above, for execution on an embedded device.

In FIG. 2A the sensor 201 and the worker 203 are part of a Federated Learning (FL) system. The worker 203 generates and updates a local model 105 based on the training data received from the sensor 201. The parameters of the local machine learning model are communicated to a parameter server (not shown). These parameters, along with parameters from other workers in the Federated Learning (FL) deployment are aggregated by the parameter server and an updated global model is generated. The updated global model is subsequently communicated to the worker 203, which subsequently communicates the machine learning model to the sensor 201 for use in generating inferences.

FIG. 2B shows a distributed machine learning architecture according to another arrangement. FIG. 2B shows a sensor 206 and a worker 207 having similar components to FIG. 2A. In the alternative arrangement of FIG. 2B the worker 207 updates the model but does not form part of a Federated Learning system. In this arrangement the worker 207 trains and updates a machine learning model locally, independent of any global model. The worker 207 does not pass parameters to a parameter server or receive a global model. The worker may be implemented locally to the sensor (e.g. in a processor within the same device as the sensor, or in a device that has a local connection to the sensor), or may be implemented in the form of a centralised server (e.g. a cloud server). The locally generated machine learning model is subsequently transmitted to the sensor 206. In other words, the functionality of the worker 203 in FIG. 2A to receive a global model from a parameter server and to transmit a local model to a parameter server is not present in the arrangement shown in FIG. 2B.

In the distributed machine learning architectures of FIG. 2A and FIG. 2B training data is communicated from the sensor to the worker in order to train the machine learning model to account for environment changes over long-term deployments. The updated machine learning model is subsequently communicated from the worker to the sensor, where the updated model is used to generate inferences based on the raw data. Determining when to communicate training data from the sensor to the worker in order to retrain the machine learning model, and when to communicate an updated machine learning model from the worker to the sensor affects the accuracy of the model and the amount of communication resources required, and therefore affects the viability of the distributed machine learning deployment.

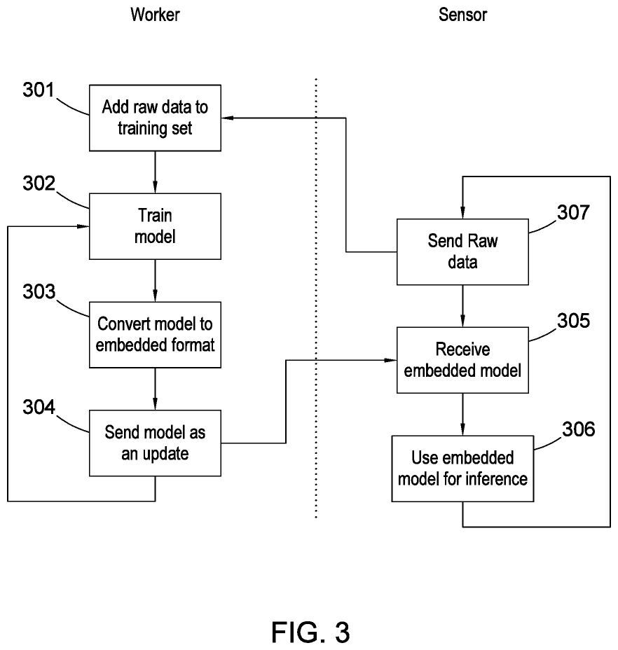

FIG. 3 shows a fixed scheduling approach for managing communications in the system of FIG. 2B. The method begins in step 301 with the worker adding raw data to a training data set, the raw data being received from the sensor. In step 302 the worker trains a machine learning model based on the updated training data set.

Optionally, in step 303 the worker converts the model trained in step 302 into an embedded format. As discussed above, an embedded format as used herein refers to an implementation of the machine learning model that is adapted to be executed on an embedded device.

In step 304 the worker communicates the machine learning model (optionally in embedded format) to the sensor as an update. After communicating the updated machine learning model in step 304, the worker continues training the model in step 302 using the updated training set.

The updated model in embedded format is received by the sensor in step 305. The sensor subsequently uses the updated embedded model in step 306 for generating inferences based on the raw data it generates. It will be appreciated that if the machine learning model is transmitted in its original format in step 304 (i.e. not in embedded format) then steps 305 would involve receiving the machine learning model and using the machine learning model (not in embedded format) for inference.

In step 307 the sensor transmits raw data to the worker for the purpose of retraining the machine learning model. The raw data is added to the training data set in step 301 and is subsequently used to train the machine learning model as discussed above.

In the scheduling method of FIG. 3 the communication of model updates from the worker to the sensor, and the communication of raw data from the sensor to the worker occurs at fixed time intervals. For example, after a predetermined period of time has elapsed since the last transmission.

Using a fixed scheduling method is simple to implement however it does have significant drawbacks. For example, with this approach model training can fluctuate immensely before a stable well-trained model is produced. Furthermore, changes in the environment of the sensor can affect the model accuracy and fixed updates cannot react to these changes in a timely and efficient manner. Furthermore, updates may be performed even in situations where they are not needed. This increases the computational and transmission overheads. In light of this there is a need to improve distributed machine learning deployments, in particular when the machine learning model is deployed on an embedded device.

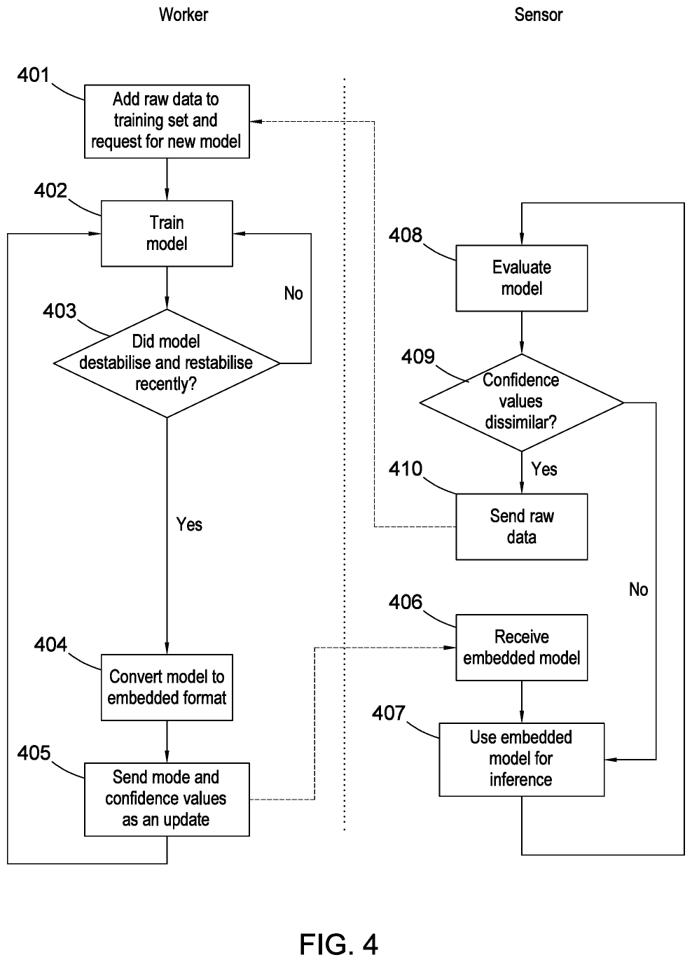

FIG. 4 shows a scheduling method for managing communication exchanges in a distributed machine learning deployment according to an arrangement. In the scheduling method shown in FIG. 4 the machine learning model is evaluated at both the worker and the sensor in order to determine whether an updated machine learning model should be transmitted from the worker to the sensor and to determine when new training data should be communicated from the sensor to the worker for addition to the training set. As will be apparent from the description below, this approach reduces the total amount of communication between the worker and sensor nodes while still maintaining the ability of the system to adapt to changes in the environment.

In step 401 the worker receives raw data from the sensor and adds the received raw data to the data sets maintained by the worker. The system of FIG. 4 uses four data sets:
1) A worker training data set, used by the worker for training a machine learning model.
2) A worker validation data set, that is not used for training, but is instead used in the method of FIG. 4 to determine model stability of a model that has been recently trained by the worker.
3) A worker sensor data set that is used to assess the performance of the machine learning model. The worker sensor data set is also referred to as the worker test data set.
4) A sensor test data set, used by the sensor to detect an occurrence of drift at the sensor.

In response to receiving raw data from the sensor, the worker adds the received raw data to the worker training data set and the worker sensor data set. Optionally, the received raw data is separated into two sets, one being added to the worker training data set and the other to the worker sensor data set maintained by the worker. For example, of 1000 samples raw data samples received in step 401, 700 samples may be added to the worker training data set and 300 samples may be added to the worker sensor data set. The worker subsequently generates a new worker validation data set by selecting a subset, optionally a small subset, of the updated worker training data set. The new worker validation data set is used solely for evaluating the stability of a model that has been recently trained by the worker.

In one example, adding data received from the sensor to the data sets maintained by the worker comprises labelling the data received from the sensor before the data is added to the corresponding data sets. This approach is followed when the system uses supervised learning (i.e. when the system is used for supervised machine learning problems). In one example the data samples from the sensor are labelled by a human-in-the-loop (i.e. a user who assigns labels to the data received from the sensor) before the received samples enter the training system (specifically, the data sets maintained by the worker).

It will be appreciated that labelling the samples received from the sensor is not required for unsupervised learning problems. The worker subsequently generates a request to generate a new machine learning model (i.e. an updated version of the machine learning model) based on the updated training set.

In step 402 the worker trains the machine learning model based on the updated training set from step 401. Training a machine learning model refers to a process where parameters (e.g. weights) of a machine learning model are generated based on a set of training data. For example, in supervised learning training a machine learning model comprises building a predictive model by examining many examples comprising input data and an associated observation, and attempting to find a version of the model (e.g. by varying the parameters) that minimises discrepancies between a model prediction based on the input data and the observation associated with the input data.

In step 402 the machine learning model is trained for a period of time corresponding to a time window (w). During a time window (w) the worker trains the machine learning model a plurality of times and calculates a training loss and a validation loss after each training iteration. As an example, the number of training iterations in a time window could be 10 (i.e. N=10). Consequently, in this example the worker calculates 10 training losses and validation losses for each time window. Successive time windows may be overlapping or non-overlapping.

In one arrangement, successive time windows do not overlap, consequently in this example two time windows comprise 20 training iterations, each iteration being associated with a different time. Or in other words, when non-overlapping time windows are used the machine learning model is trained for N iterations (e.g. 10 iterations) for the first time window, and then N further iterations must be completed before the second time window can be formed.

In another arrangement successive time windows are overlapping. The amount of overlap between successive time windows depends on a step size being used. In one example a window size of N=10 iterations is used with a sliding (i.e. overlapping) window with a 50% overlap. In this example the first window comprises 10 training iterations. 5 further training iterations are then required in order to form the second time window. In this case the first time window and the second time window share 5 training iterations (e.g. the last 5 training iterations from the first time window). Each subsequent time window is formed after 5 further training iterations have been performed.

The training loss represents a difference between a machine learning model prediction (output) and an observation when the machine learning model is tested with the training data set. Likewise, the validation loss represents a difference between a machine learning model prediction (output) and an observation when the machine learning model is tested with a validation data set. In the method of FIG. 4 the worker validation data set is used to calculate a validation loss.

In step 403 the worker determines whether the machine learning model has destabilised and re-stabilised recently. For each time window (w) the worker firstly calculates a mean absolute loss difference according to:

$${Δ}_{w ( loss )} = \frac{1}{N} {{\sum }_{i}}^{N} \vert {τ}_{i ( training loss )}^{w} - {φ}_{i ( validation loss )}^{w} \vert$$

Where:
τ is the training loss;
φ is the validation loss using the worker validation data set;
w is the time window; and
N is the number of training iterations per time window.

In step 403, the worker obtains the mean absolute loss differences for at least two time windows, preferably the most recent at least two time windows and calculates statistical metrics in order to assess the model stability and the machine learning model's suitability for deployment to the sensor.

Determining whether the machine learning model has destabilised and re-stabilised recently comprises a two-step test. Firstly, the worker determines whether the machine learning model is unstable. The machine learning model at the worker (that was being trained in step 402) is marked as unstable if the mean absolute loss difference for a (single) time window is above a first threshold, a.

Optionally, the first threshold, a, is predetermined. Preferably, the first threshold, a, is a modifiable threshold. The first threshold, a, controls the frequency of model communication between the worker and the sensor and can be set according to model accuracy requirements as well as communication constraints. The first threshold, a, can also be statistically determined since it is dependent on the dataset and model used. For example, statistical methods (e.g. by looking at errors or using a moving average) can be used to observe the trends for a particular dataset and to determine the various thresholds used in the method, which includes the first threshold, a.

After determining whether the machine learning model is unstable (i.e. determining whether or not the mean absolute loss difference for a time window is above the first threshold, a) a second step of the test is conducted. If the model is determined to be unstable then it is determined whether the machine learning model has re-stabilised recently. This includes determining whether the standard deviation of the mean absolute loss difference for the at least two time windows falls below a second threshold w. If the standard deviation of the values representing the mean absolute loss difference for each time window falls below the second threshold, w, then it is determined whether the gradient of a line, m, of best fit (calculated using least squares method) between the mean absolute loss difference for each time window is within a third threshold, ±λ, (i.e. between −λ and +λ). If it is found that the gradient of a line, m, of best fit between the mean absolute loss difference for each time window is within the third threshold, ±λ, then the model is determined to be suitable for deployment.

Optionally, the third threshold, λ, is adjustable and is based on factors such as model update frequency. Optionally the third threshold, λ, is set to 0.005.

If, in step 403, it is determined that machine learning model at the worker is not suitable for deployment, then the method returns to step 402 and the worker trains the machine learning model for at least another time window using the existing training data on the worker/training node. In effect training the machine learning model further and shifting the time windows over which the stability determination is made over.

If, in step 403, it is established that the machine learning model at the worker is suitable for deployment then the method proceeds to step 404.

In step 404 the machine learning model is converted to an embedded format.

This step is particularly useful for embedded devices that have reduced computational capability. An example of an embedded format is Tensorflow™ Lite format for deep learning models. Tensorflow™ Lite is the deployment of Tensorflow™ models (Tensorflow™ is an end-to-end machine learning platform) on to embedded devices or mobile phones. The lightweight model can be used for inference and is easily accessible in single exported files that are entirely self-contained. TensorFlow™ Lite models use optimisation techniques such as quantisation and delegates to improve inference speed without sacrificing accuracy. This allows for fast inference on less computational capable devices, such as sensors.

After completing step 404, the method proceeds to step 405. Before transmitting an updated machine learning model the worker generates a set of confidence scores by inputting the worker sensor data set as an input to the updated machine learning model. As will become apparent from the description below, the confidence scores associated with the worker sensor data set will be used to detect an occurrence of concept drift at the sensor.

In step 405 the worker communicates the updated machine learning model from step 402 as an update to the sensor. The worker also transmits a set of validation confidence scores generated when testing the instance of the machine learning model being transmitted as an update with the worker sensor data set stored by the worker.

It will be appreciated that step 404 is optional, and depending on the processing resources of the embedded device it may be possible to send the machine learning model to the sensor without converting it to an embedded format (i.e. proceed directly from step 403 to 405). For example conversion to an embedded format is not necessary for sensors that support full machine learning models.

After transmitting the updated machine learning model as an update, the method proceeds to step 402 where the worker continues to train the machine learning model based on the updated training set.

Turning now to the operation of the sensor. In step 406 the sensor receives the machine learning model transmitted by the worker. The sensor also receives the set of validation confidence scores generated when testing the received machine learning model with the worker sensor data set. It will be appreciated that the sensor may receive the machine learning model not in an embedded format, depending on the transmission of the worker.

After receiving the machine learning model as an update in step 406, the method proceeds to step 407 where the sensor uses the machine learning model received in step 406 to make inferences based on the raw data at the node sensor. As an example, the raw data at the sensor includes locally generated measurements or observations.

After making inferences in step 407, the method proceeds to step 408 where the machine learning model is evaluated.

In step 408 the sensor generates a new test data set, s. The new test data set, s, comprises raw data measured or observed by the sensor. In one example the new test data set, s, comprises: part of a previous test data set that was used to assess the machine learning model deployed on the sensor, as well as raw data measured or observed by the sensor since the previous test data set was generated. Optionally the data included in the new test data set, s, is a subset of the raw data measured or observed since the previous test data set was generated. Each time samples are introduced to the new data set the amount of noise is the test data set can change. The new test data set, s, is equivalent to an updated instance of the sensor test data set.

In order to determine the model quality at the sensor, the sensor compares confidence values generated using the worker sensor set (as communicated from the worker in step 405) and confidence values generated by applying the new test data set, s, (comprising the real time sensor data) to the machine learning model used by the sensor for inference in step 407. In particular the sensor determines the model quality, by comparing a Cumulative Distribution Function (CDF) of the confidence values received from the worker in step 405 and a Cumulative Distribution Function (CDF) of the confidence values generated from the test set, s, generated from real time sensor data at the sensor.

In step 409 the sensor determines whether confidence values are dissimilar, specifically whether the confidence values transmitted in step 405 are dissimilar to confidence values generated from a test set comprising raw data. In an example the sensor determines whether the Cumulative Distribution Function (CDF) of the confidence values received from the worker in step 405 and the Cumulative Distribution Function (CDF) of the confidence values generated from the test set, s, are dissimilar.

If the Cumulative Distribution Functions (CDF) of the confidence scores are similar then it is indicative that the deployed model on the sensor is still effective for the current dataset (i.e. the raw data currently being measured/obtained by the sensor). As a result the sensor can continue making inferences using the current model (i.e. without the need to transfer new data to the worker to retrain the machine learning model).

Put another way, if the Cumulative Distribution Functions (CDF) of the confidence scores are similar then it can be concluded that drift has not occurred at the sensor. Drift refers to a situation where features of the data being used by the machine learning model changes over time (e.g. an unseen variety of data is introduced or the distribution of the data changes, such as where there is a significant change in the characteristics of the environment being observed). The deployed machine learning model was not trained for this variety or distribution of data. Consequently it is likely that the confidence scores associated with the inferences of the machine learning model will be different to those generated with the worker validation test set.

If it is determined in step 409 that the Cumulative Distribution Function (CDF) of the confidence values received from the worker in step 405 and the Cumulative Distribution Function (CDF) of the confidence values generated from the test set, s, are similar, then the method proceeds to step 407 where the sensor continues to make inferences based on the current machine learning model at the sensor.

If the Cumulative Distribution Functions (CDF) of the confidence scores are not similar then it is indicative of a change in the data distribution of the test set, s, for example due to the addition of noise. If it is determined in step 409 that the Cumulative Distribution Function (CDF) of the confidence values received from the worker in step 405 and the Cumulative Distribution Function (CDF) of the confidence values generated from the test set, s, are not similar, then the sensor proceeds to step 410.

In step 408 the sensor compares a Cumulative Distribution Function (CDF) of the confidence values received from the worker in step 405 and a Cumulative Distribution Function (CDF) of the confidence values generated from the test set, s. Preferably the sensor uses a statistical measure such as a Kolmogorov-Smirnov (KS) test that compares the Cumulative Distribution Function (CDF) of the received confidence values with the Cumulative Distribution Function (CDF) of the confidence values generated from the test set, s (θₛ).

The Kolmogorov-Smirnov (KS) test is a statistical test that is used to compare two sample probability distributions (two-sample KS test) to determine a difference between the two distributions. In essence, the Kolmogorov-Smirnov (KS) test quantifies a distance between the distributions of the two samples and is sensitive to both the location and the shape of the cumulative distribution functions being compared. The Kolmogorov-Smirnov (KS) test generates a value between 0 and 1. A value of 0 indicates that the Cumulative Distribution Functions (CDFs) being compared are highly similar, whereas a value of 1 indicates that the Cumulative Distribution Functions (CDFs) being comparted have a low similarity.

If there is a change in the data distribution, then the value generated by the Kolmogorov-Smirnov (KS) will increase indicating that there is a low similarity between the Cumulative Distribution Function (CDF) of the worker sensor data set confidence values and the Cumulative Distribution Function (CDF) of the confidence values generated using the test data set formed by the sensor. When the machine learning model improves, the Kolmogorov-Smirnov (KS) value will fall to reflect the higher similarity between two Cumulative Distribution Functions (CDFs).

Where the Kolmogorov-Smirnov (KS) test is used to generate a measure of similarity, the determination in step 409 further comprises determining whether there is a spike in the Kolmogorov-Smirnov (KS) (i.e. whether the Kolmogorov-Smirnov (KS) value has exceeded a threshold, thereby indicating that the similarity between the Cumulative Distribution Functions (CDFs) has reduced and an updated machine learning model is required).

In FIG. 4, if the similarity between the Cumulative Distribution Functions (CDFs) has reduced and an updated machine learning model is required then the method proceeds to step 410 and transmits raw data to the worker, thereby creating a request for a model update at the worker. In this case, this request is sent when:

θₛ>θₛ₋₁+β

### Where:

θₛ is the Kolmogorov-Smirnov (KS) test value generated when comparing the cumulative distribution function (CDF) of the received confidence values with the CDF of the confidence values generated from the test set, s.

θₛ₋₁ is the Kolmogorov-Smirnov (KS) test value generated when comparing the cumulative distribution function (CDF) of the received confidence values associated with the previously received machine learning model with the CDF of the confidence values generated from the test set, s-1, i.e. the CDF associated with the previous machine learning model at the sensor; and

β is a third threshold between 0 and 1.

Optionally, the third threshold, β, is predetermined. Preferably, the third threshold, β, is a modifiable threshold. The third threshold, β, controls the frequency of data communication between the sensor and the worker and can be set according to model accuracy requirements as well as communication constraints. The third threshold, β, can also be statistically determined since it is dependent on the dataset and model used.

Although the Kolmogorov-Smirnov (KS) test is discussed above to compare similarity it will be appreciate that other statistical measures could be used instead. Other tests that could be used include, but are not limited to: a student t-test, Kullback-Leibler divergence, or Jenson Shannon divergence. In fact, any test that is capable of detecting a change in model confidences (e.g. between worker sensor data set and sensor test data set confidences) could be used in step 408.

In step 410 the sensor communicates recently received/observed data to the worker for use in further training of the machine learning model. Where the machine learning model uses Supervised Learning (SL), the communicated data is labelled (e.g. by adding one or more meaningful and informative labels so that a machine learning model can learn from the data). Labelling is preferably carried out at the worker.

As discussed above, the worker receives the raw data in response to the sensor transmitting the raw data in step 410. The worker subsequently adds the raw data to the worker training data set and the worker sensor data set (also referred to as the worker test set) and generates a request to train a new machine learning model as described in relation to step 401.

The worker also generates a new worker validation data set. There are various ways to update the worker validation data set including: selecting a subset, optionally a small subset, of the updated training data set. Another option is to split the data communicated by the sensor into three parts and use a different part for updating the worker training set, the worker validation set and the worker sensor set.

The above-described method solves a number of problems. In particular concerning identifying when a machine learning model is optimal for deployment and when a machine learning model is outdated and requires re-training, particularly when the machine learning model is deployed in a distributed environment.

As will be appreciated from the above, the method facilitates the evaluation and control of both model deployment and retraining such that the model can constantly adapt to changes in environment whilst keeping data transfer to a minimum. The method described above limits data transfer between the worker (where models can be trained) and sensor(s) (where data is collected and the models are implemented) by evaluating the model at each edge device and making decisions on when an update should occur. The proposed methods can be applied to large scale deployments over the long term, maintains high accuracy levels, and adapts to environmental changes with optimised communication overheads. In particular the proposed method can be applied to large scale Federated Learning (FL) deployments.

Implementing the method described above requires two new subsystems, one placed on the worker and the other on the sensor. The systems evaluate the machine learning model at both the edge and sensor devices to decide when the model should be sent to the sensor and when new training data should be sent to the worker for further training.

This greatly reduces the total number of communications between the worker and the sensor while still allowing the model to adapt to changes in the environment. The benefits of this strategy can be seen for large scale IoT deployments, where there are many workers and sensors. By avoiding unnecessary data transfer, communication and power resources can be saved.

Model confidence has previously been used to evaluate a machine learning model's stability during training or when it is deployed, however it is not always reliable particularly when using deep neural networks as the base machine learning model. The proposed method uses the variance of the absolute difference of the loss when evaluating the model using training and worker validation data sets; effectively relying on the divergence between the model's loss when using training and worker validation data. Worker validation data can be a small subset of a given training dataset that is not used for the training steps. In the method described above, the machine learning model is validated at the edge (training) worker using the worker validation data set during training iterations. This is an improved metric to detect instability of a model during training particularly when new data that has different statistical properties is added to the training set.

The method described above also provides a way to detect model quality when the machine learning model is deployed. Without consistently sending new data back to the worker (or training node) for further training, the deployed model would be unable to detect the change in environment at the sensor. As discussed above, naïve algorithms that send data at fixed intervals will include unnecessary communications which could be expensive in bandwidth limited applications. The method described above introduces the use of a statistical test (e.g., a Kolmogorov Smirnov test, student t-test, Kullback-Leibler divergence, or Jenson Shannon divergence) to detect the change in model confidences (between worker sensor data set confidences and sensor test set confidences) and schedule updates depending on the result. During deployment, model test confidences are the only metrics usable for assessing model quality; however, as stated above, relying solely on confidences can be very unstable for a few widely used ML models. The methods described herein therefore rely on the change in the model's confidences for test and worker sensor data. There is an additional overhead of communicating worker sensor confidences to the sensor along with the machine learning model. However, the benefits are realised in a reduced communication cost as raw data from the sensor is only scheduled if the model quality has deteriorated.

The proposed system also does not rely on specific model parameters or the input data and hence can be generalisable to different datasets (images, speech, time-series) and model types (CNNs, RNNs, LSTMs, Autoencoders).

It can also be deployed in non-Federated Learning (FL) systems, as long as there are two distinct training and inference nodes (e.g., a cloud-edge architecture where training is performed on the cloud and inference is performed at the edge). For example, even though in the above description the term sensor is used, it is noted that the methods and functionality described in relation to the sensor are, in an arrangement, performed by a node (otherwise referred to as a node sensor). Since the node's primary purpose is generating inferences based on the raw data this node is referred to as the inference node. Likewise even through in the above description the term worker is used, it is noted that the methods and functionality described in relation to the worker are, in an arrangement, performed by another node. Since the node's primary purpose is training the machine learning model, this node is referred to as the training node. As discussed in more detail below, a node can be realised using a computing apparatus.

The method described above was tested using a machine learning model adapted for image recognition of the Modified National Institute of standards and Technology (MNIST) database of handwritten digits, also referred to as LeCun, Y. & Cortes, C. (2010), ‘MNIST handwritten digit database’, which is incorporated herein by reference. The method described above was tested using training, validation, and test data sets. The initial training dataset comprised 10000 images from the MNIST database, the worker validation dataset comprised 2500 images from the MNIST database, the worker sensor dataset comprised 1000 images from the MNIST database and the sensor test data set comprised 1000 images from the MNIST dataset.

The sensor makes inferences based on data samples from the MNIST Corrupted database. This database is generated as described in “MNIST-C: A Robustness Benchmark for Computer Vision, Norman Mu and Justin Gilmer, 2019”, which is incorporated herein by reference. Introducing noisy data like this affects the deployed machine learning model's performance. During testing the noise level of the images from the corrupted database was gradually increased to simulate a gradual change in the test data distribution.

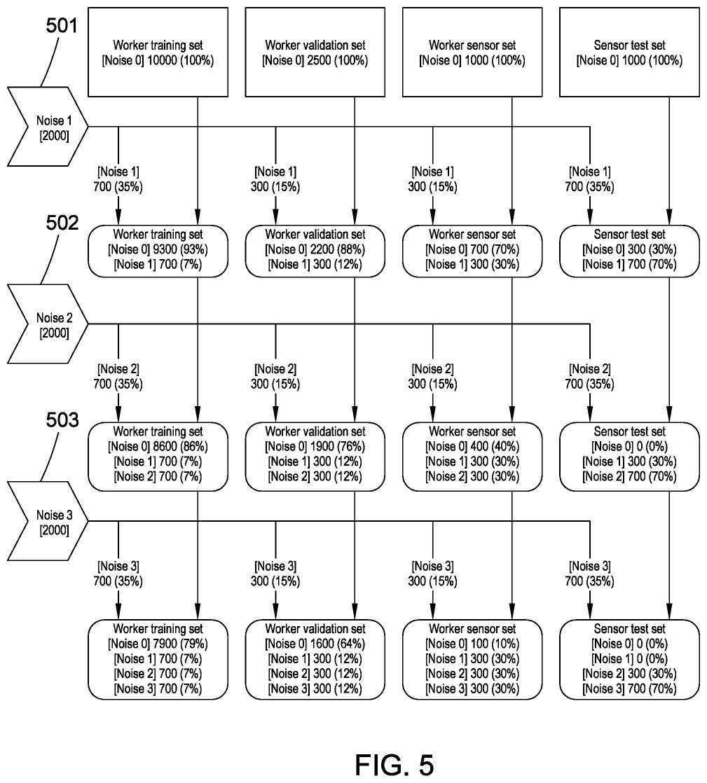

FIG. 5 shows how the data sets are updated over time according to an arrangement. In particular, FIG. 5 shows how new data samples received/observed by the sensor are incorporated in the training, validation and test data sets. At a first time 501, 2000 noisy data samples are introduced at the sensor. After receiving a predetermined number of new data samples at the sensor (or alternatively after a predetermined amount of time has elapsed) the sensor evaluates the machine learning model deployed on the sensor (e.g. step 408 in FIG. 4) using an updated sensor test data set that includes at least part of the recently received/observed data samples.

In the example shown in FIG. 5, of the 2000 noisy data samples introduced at the sensor and 700 samples (i.e. 35% of the samples) are used to update the sensor test set. The 700 noisy samples replace 700 samples from the original sensor test data set (comprising 1000 images from the MNIST database). As discussed in relation to FIG. 4, in step 409 the sensor determines whether the confidence values transmitted in step 405 are dissimilar to confidence values generated from the sensor test set comprising “new” data. If the confidence values are dissimilar then data is communicated to the worker in step 410. In the example shown in FIG. 5, data is communicated to the worker. In this case, 1300 samples of the 2000 noisy data samples (i.e. 65% of the samples) are communicated to the worker. Of the 1300 samples received by the worker 700 samples are added to the worker training set. These 700 samples replace 700 samples from the original worker training set (comprising 10000 images from the MNIST database) so that the total number of samples in the worker training set remains 10000.

Likewise, 300 of the 1300 noisy data samples received by the worker are added to the worker validation data set. The 300 noisy data samples replace 300 samples from the original worker validation data set (comprising 2500 images from the MNIST database). Finally 300 of the 1300 noisy data samples received by the worker are added to the worker test data set. The 300 noisy data samples replace 300 samples from the original worker sensor set (comprising 1000 images from the MNIST database).

At a second time 502, 2000 more noisy data samples are introduced at the sensor. As discussed above, the sensor initially updates the sensor test data set to include the recently observed data. The sensor adds 700 noisy samples (generated at the second time 502) to the sensor test data set. These 700 noisy samples replace the “oldest” samples (i.e. the samples that are associated with/recorded at a time furthest in the past relative to the current time). In this case the 700 noisy samples to be added, at the second time 502, to the sensor test set replace 300 samples (corresponding to the original samples from the MNIST database) and 400 of the 700 samples from the first time 501 that were introduced to the sensor test data set. Consequently, the number of samples in the sensor test set remains at 1000.

In the example of FIG. 5, data is communicated to the worker after determining that confidence values generated based on the sensor test data set (updated to include noisy samples from the second time 502) are dissimilar to the confidence values received from the worker (thereby triggering an exchange of data from the sensor to the worker). Consequently a similar process (i.e. replacing the “oldest” samples of the data sets with newer samples from the second time 502) is followed when updating the worker training set, the worker validation data set and the worker sensor set. A similar process is also shown for the third time 503.

Although the example of FIG. 5 shows specific percentages (e.g. 35% of the data samples are used to update the sensor test set, 15% of the data samples are used to update the worker test set, 15% of the data samples are used to update the worker validation data set, 35% of the data samples are used to update the worker training data set), it will be appreciated that different percentages could be used. Furthermore, although the example shown in FIG. 5 uses data sets of specific size (e.g. worker training data set comprises 10000 data samples, worker validation data set comprises 2500 data sampled, worker test data set comprises 1000 samples, sensor test data set comprises 1000 samples), it will be appreciated that data sets of other sizes could also be used.

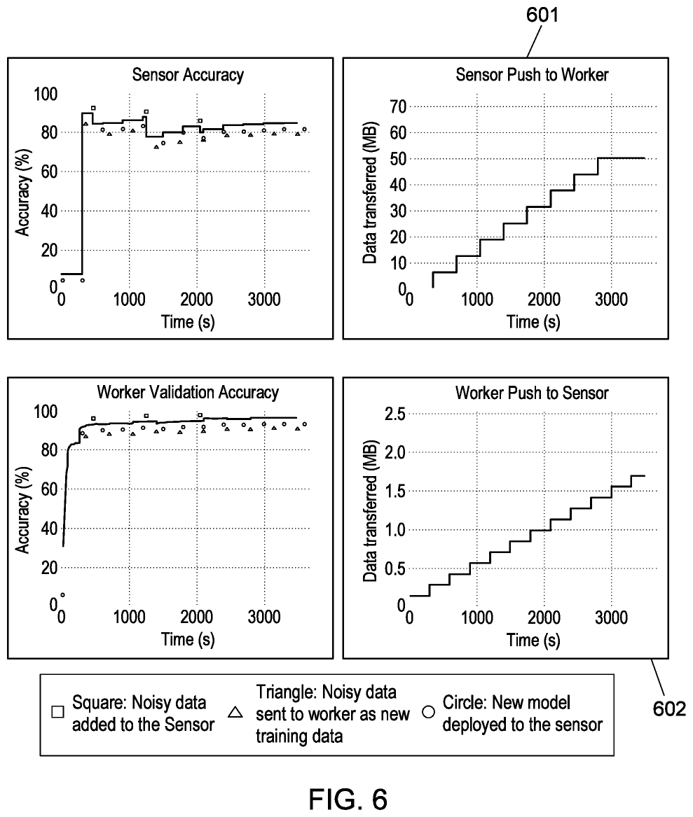

FIG. 6 shows the performance of a distributed system using naïve scheduling to control data and model exchanges between the sensor and the worker. In FIG. 6 the naïve scheduling system is configured to transfer data at fixed intervals every 300 seconds. FIG. 6 shows a first plot 601 and a second plot 602. The first plot 601 and the second plot 602 in particular highlight that the communications between the sensor and the worker occur at fixed intervals.

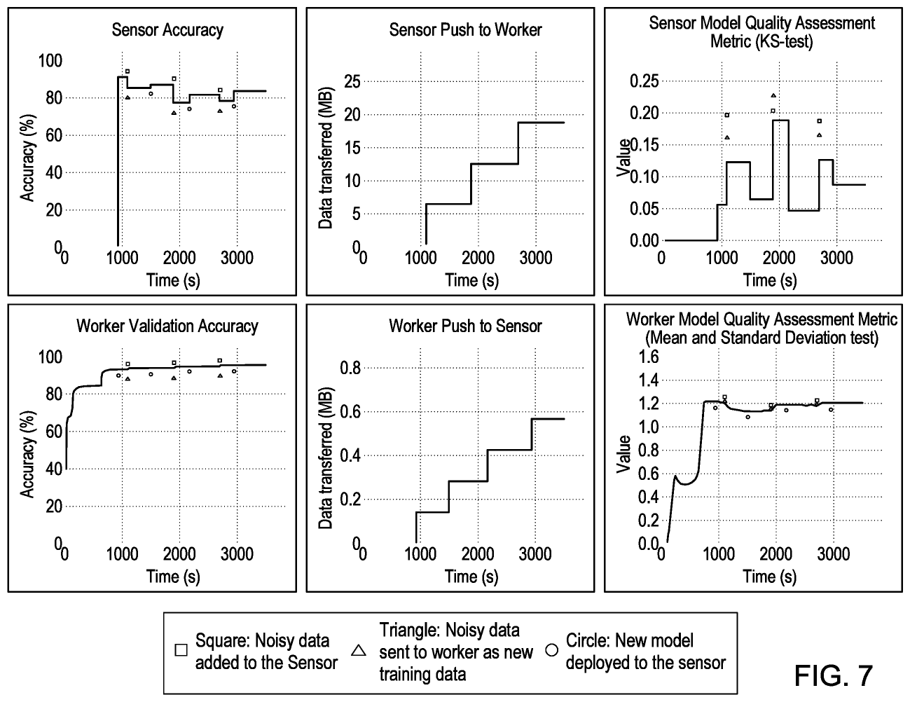

FIG. 7 shows the performance of a distributed system using the scheduling method according to an arrangement. In particular FIG. 7 shows that method of managing communication of model and data information disclosed herein reduces the amount of communication between the sensor and the worker while maintaining high sensor accuracy and high worker validation accuracy.

By comparing the mean/standard deviation of the absolute loss differences for every time window, w, the model's stability can be measured as detailed above. Once a stable model with a high accuracy has been established, it is deployed to the sensor for inference. As described above, the sensor proceeds to introduce new noisy test data in the simulation (using the MNIST corrupted dataset) which affects the model's performance.

The sensor replaces samples of test data (from the test data set maintained by the sensor) with samples of new noisy test data (generated from the MNIST Corrupted database).

The sensor scheduler detects this change in performance by using a statistical test between worker sensor data set confidences and the sensor test data confidences (as described above). The sensor then communicates the recently observed/introduced noisy data to the worker for use in further training. The worker (i.e. the training node) splits the received data and adds part of the received samples to the training data set, part of the received samples to the validation data set and part of the received samples to the worker test data set. The worker subsequently begins training a new machine learning model. This cycle repeats itself, actively reacting to the change of the model both at the worker and the sensor to determine when an appropriate update should be made. By using the tests described above, the amount of communications between the worker and the sensor is limited.

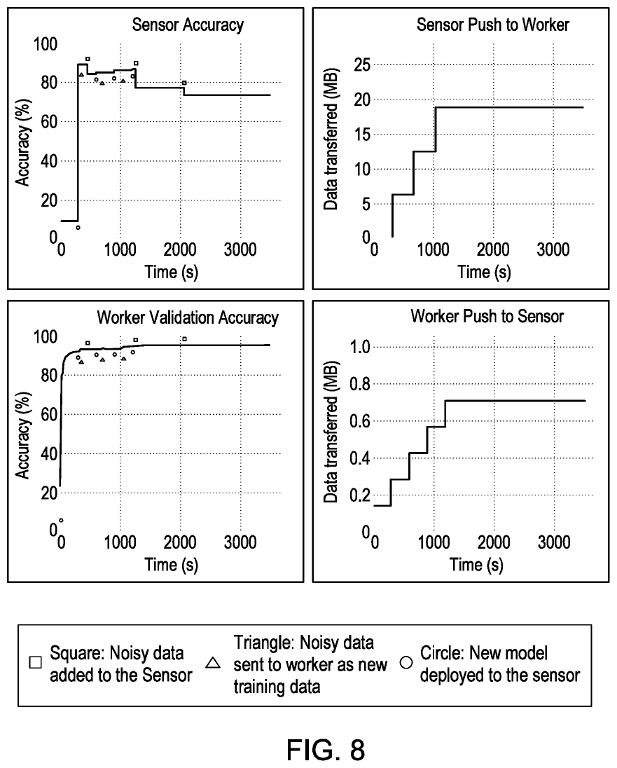

FIG. 8 shows the performance of a distributed system using naïve scheduling to control data exchanges but with data restricted to the same amount as occurs when using the method according to an arrangement. In particular FIG. 8 shows that when subject to the same amount of communication between the sensor and the worker (i.e. a reduced amount of communication), naïve scheduling results in a worse performance (e.g. a lower sensor accuracy).

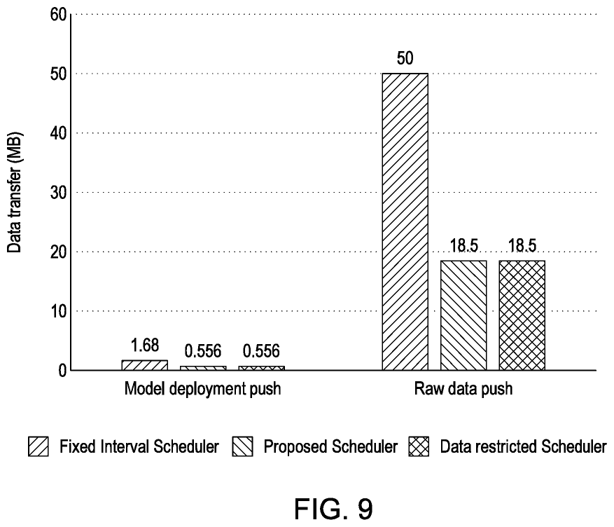

FIG. 9 shows a comparison of data transfer between the worker and the sensor when using the fixed interval (naïve) scheduler, a data restricted fixed interval (naïve) scheduler and a scheduler according to an arrangement. In particular, FIG. 9 shows that the approach disclosed herein reduces the amount of communication between the worker and the sensor that is associated with the communication of an updated machine learning model (i.e. the model deployment push) as compared to the fixed interval (naïve) scheduler.

FIG. 9 also shows that the approach disclosed herein reduces the amount of communication between the sensor and the worker associated with the communication of raw data (i.e. the raw data push) as compared to the fixed interval (naïve) scheduler. FIG. 9 shows that the approach disclosed herein requires a similar amount of data transfer as a data restricted fixed interval (naïve) scheduler. However, as discussed in relation to FIG. 8, the method disclosed herein achieves improved sensor accuracy.

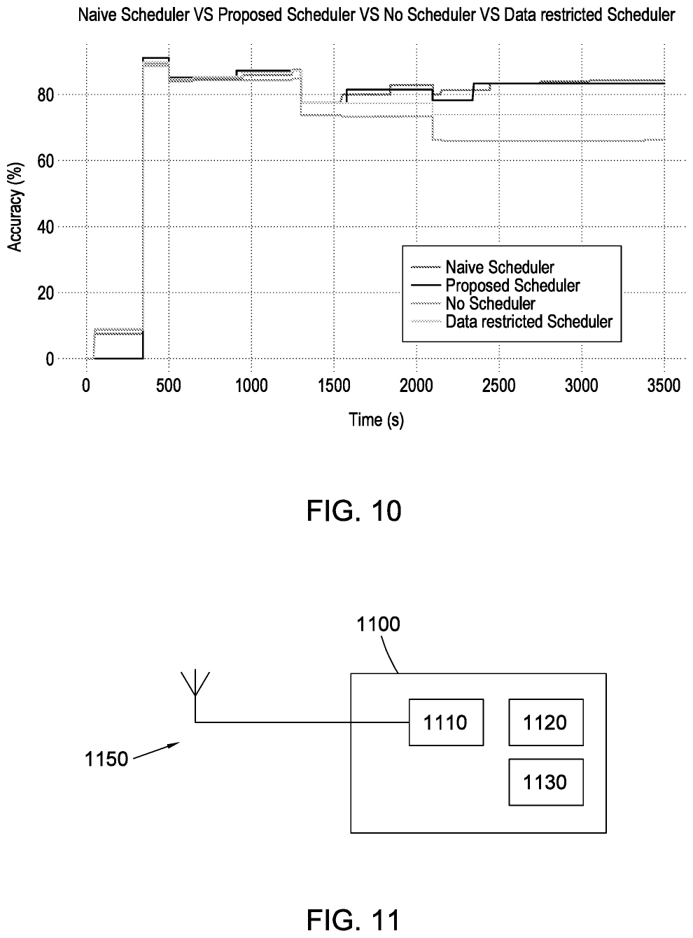

FIG. 10 shows a comparison of the deployed model accuracy at the sensor when using no scheduling, the fixed interval (naïve) scheduler, a data restricted scheduler, and a scheduler according to an arrangement. When no scheduling is used, the machine learning model at the sensor node is not updated. Without new data being communicated from the sensor to the worker for training, the deployed model's accuracy gradually decreases over time and never recovers. Using the proposed scheduling system, data transfer is greatly reduced without sacrificing model accuracy. This can be seen in FIG. 10, which shows the method according to an arrangement achieving a similar model accuracy to the fixed interval (naïve) scheduler. However, as will be appreciated from FIG. 9, this is obtained with reduced communication overhead.

FIG. 11 shows a node according to an arrangement. The node 1100 comprises an input/output module 1110, a processor 1120 and a non-volatile memory 1130. The input/output module 1110 is communicatively connected to an antenna 1150. The antenna 1150 is configured to receive wireless signals from, and transmit wireless signals to, other nodes. The processor 1120 is coupled to the input/output module 1110 and to the non-volatile memory 1130. The non-volatile memory 1130 stores computer program instructions that, when executed, cause the processor 1120 to execute program steps that implement the functionality of a training node or an inference node as described in the above-methods.

Whilst in the arrangement described above the antenna 1150 is shown to be situated outside of, but connected to, the node 1100 it will be appreciated that in other arrangements the antenna 110 forms part of the node 1100. In a further arrangement the node communicates with other nodes via a wired connection. In this case the input/output module 1110 is further configured to communicate with other nodes via a wireless interface. In a further arrangement the input/output module 1110 is only configured to communicate with other nodes via a wired interface.

As will be apparent from the above description, the proposed system is particularly beneficial for large scale IoT deployments where large datasets are being generated. There are numerous potential applications for this technology, including agriculture management (managing farming animal & growing plants), environment management (managing forests & predicting disasters), and autonomous vehicle control (e.g. self-driving vehicles).

One specific application is CCTV systems including many cameras. Instead of streaming video feeds to edge device, on device inference can be made and model updates can be requested when required. In one example the machine learning model is configured to classify people (i.e. humans) to aid in intrusion detection. In this case image data (e.g. a time series of images) is analysed using the machine learning model to determine whether a person is present in the image data.

In another example the proposed system is used for predictive maintenance of machines using time series data generated by the machine. A node device uses data collected to predict the health and possible failure of devices. In one example the time series data includes data generated by sensors observing the behaviour of the machine and/or the environment in which the machine resides. In this example the machine learning model is configured to determine whether a fault and/or outage is likely in the immediate future and, based on this determination, determine whether any action can be taken (e.g. by a technician) to avoid the fault. Optionally the system in this example is also configured to provide an output instruction (e.g. a notification) to maintain the machine. Thereby prompting the technician to interact with the machine and prevent a fault and/or outage.

Oher use cases are also possible. For example the disclosed method and systems could be used for (image based) object recognition tasks. In this example the machine learning model is configured to recognise objects in image data presented at the input of the machine learning model. Other example use cases include a system where the machine learning model is configured to detect anomalies in Magnetic Resonance Imaging (MRI) images.

Other example use cases include sales prediction based on historic sales data (time series data) and cyber security applications such as intrusion detection (based on network traffic time series).

In all the examples above, the machine learning models used by the sensor node may drift over time, thereby requiring constant updates to maintain accuracy.

While certain arrangements have been described, the arrangements have been presented by way of example only, and are not intended to limit the scope of the inventions. Indeed, the novel methods and devices described herein may be embodied in a variety of other forms; furthermore, various omissions, substitutions and changes in the form of the methods and systems described herein may be made.

1. A method for managing a deployment of a machine learning model in a system comprising a training node and an inference node, the method comprising:
training, by the training node, the machine learning model based on a training data set;
generating, by the training node, a first set of confidence scores comprising confidence scores associated with an output of the machine learning model when a first validation data set is inputted to the machine learning model;
transmitting, by the training node to the inference node, the first set of confidence scores and a representation of the machine learning model;
receiving, by the inference node, the first set of confidence scores and the representation of the machine learning model;
generating, by the inference node:
inferences by inputting data obtained by the inference node into the machine learning model; and
a second set of confidence scores comprising confidence scores associated with the inferences;
determining, by the inference node, whether the first set of confidence scores and the second set of confidence scores are similar; and
in response to determining that the first set of confidence scores and the second set of confidence scores are not similar:
transmitting, by the inference node to the training node, at least part of the data for training an updated machine learning model;
receiving, by the training node, the at least part of the data; and
in response to receiving the at least part of the data, adding, by the training node, the at least part of the data to the training data set.

2. The method according to claim 1, further comprising:
generating, by the inference node, a first cumulative distribution function based on the first set of confidence scores; and
generating by the inference node, a second cumulative distribution function based on the second set of confidence scores,
wherein:
determining, by the inference node, whether the first set of confidence scores and the second set of confidence scores are similar further comprises:
determining whether the first cumulative distribution function and the second cumulative distribution function are similar.

3. The method according to claim 2, wherein determining whether the first cumulative distribution function and the second cumulative distribution function are similar comprises:
generating a measure of difference between the first cumulative distribution function and the second cumulative distribution function using a Kolmogorov-Smirnov (KS) test; and
determining that the first cumulative distribution function and the second cumulative distribution function are not similar in response to determining that the measure of difference is greater than a first threshold.

4. The method according to claim 3, wherein the first threshold equals a sum of: a previous measure of difference generated using the Kolmogorov-Smirnov (KS) test and a first predetermined value.

5. The method according to claim 1, further comprising:
determining, by the training node, whether the machine learning model has destabilised and re-stabilised after training the machine learning model; and
in response to determining that the machine learning model has destabilised and re-stabilised: transmitting, by the training node to the inference node, the first set of confidence scores and the representation of the machine learning model.

6. The method according to claim 5, wherein:
training, by the training node, the machine learning model further comprises:
training the machine learning model for a plurality of training iterations, wherein each iteration in the plurality of training iterations comprises updating parameters of the machine learning model; and
determining whether the machine learning model has destabilised further comprises:
determining a mean absolute loss difference for the plurality of training iterations; and
determining whether the mean absolute loss difference for the plurality of training iterations is greater than a second threshold.

7. The method according to claim 6 wherein:
determining the mean absolute loss difference for the plurality of training iterations comprises:
calculating a training loss and a validation loss for each of the plurality of training iterations; and
the mean absolute loss difference for the plurality of training iterations is determined based on an average of the training loss minus the validation loss for each of the plurality of training iterations.

8. The method according to claim 6 wherein:
the plurality of training iterations comprises a first set of training iterations and a second set of training iterations;
determining the mean absolute loss difference for the plurality of training iterations comprises:
determining a mean absolute loss difference for the first set of training iterations;
determining whether the mean absolute loss difference for the first set of training iterations is greater than a second threshold; and
determining whether the machine learning model has re-stabilised further comprises:
determining a mean absolute loss difference for the second set of training iterations;
calculating a standard deviation of: the mean absolute loss difference for the first set of training iterations and the mean absolute loss difference for the second set of training iterations;
determining whether the standard deviation is less than a third threshold; and
in response to determining that the standard deviation is less than the third threshold:
calculating a line of best fit between the mean absolute loss difference for the first set of training iterations and the mean absolute loss difference for the second set of training iterations; and
determining that the machine learning model has destabilised and restabilised recently if the gradient of the line of best fit is within a fourth threshold.

9. The method according to claim 1, further comprising training, by the training node, the machine learning model based on a training data set comprising the at least part of the data in response to receiving the at least part of the data.

10. The method according to claim 1, further comprising: adding, by the training node, a subset of the at least part of the data to a second validation data set.

11. A method of operating an inference node in a distributed machine learning deployment, the method comprising:
receiving a first set of confidence scores and a representation of a machine learning model;
generating:
inferences by inputting data obtained by the inference node into the machine learning model; and
a second set of confidence scores comprising confidence scores associated with the inferences;
determining whether the first set of confidence scores and the second set of confidence scores are similar; and
in response to determining that the first set of confidence scores and the second set of confidence scores are not similar:
transmitting, to a training node, at least part of the data for training an updated machine learning model.

12. The method according to claim 11, further comprising:
generating a first cumulative distribution function based on the first set of confidence scores;
generating a second cumulative distribution function based on the second set of confidence scores; and
wherein:
determining whether the first set of confidence scores and the second set of confidence scores are similar further comprises:
determining whether the first cumulative distribution function and the second cumulative distribution function are similar.

13. The method according to claim 12, wherein determining whether the first cumulative distribution function and the second cumulative distribution function are similar comprises:
generating a measure of difference between the first cumulative distribution function and the second cumulative distribution function using a Kolmogorov-Smirnov (KS) test; and
determining that the first cumulative distribution function and the second cumulative distribution function are not similar in response to determining that the measure of difference is greater than a first threshold.

14. The method according to claim 13, wherein the first threshold equals a sum of: a previous measure of difference generated using the Kolmogorov-Smirnov (KS) test and a first predetermined value.

15. A method of operating a training node in a distributed machine learning deployment, the method comprising:
training a machine learning model based on a training data set;
generating a first set of confidence scores comprising confidence scores associated with an output of the machine learning model when a first validation data set is inputted to the machine learning model;
transmitting, to an inference node, the first set of confidence scores and a representation of the machine learning model;
receiving the at least part of the data; and
in response to receiving the at least part of the data, adding the at least part of the data to the training data set.

16. The method according to claim 15, wherein
the method further comprises determining whether the machine learning model has destabilised and re-stabilised after training the machine learning model; and
the first set of confidence scores and the representation of the machine learning model are transmitted in response to determining that the machine learning model has destabilised and re-stabilised.

17. The method according to claim 16, wherein:
training the machine learning model further comprises:
training the machine learning model for a plurality of training iterations, wherein each iteration in the plurality of training iterations comprises updating parameters of the machine learning model; and
determining whether the machine learning model has destabilised further comprises:
determining a mean absolute loss difference for the plurality of training iterations; and
determining whether the mean absolute loss difference for the plurality of training iterations is greater than a second threshold.

18. The method according to claim 17 wherein:
determining the mean absolute loss difference for the plurality of training iterations comprises:
calculating a training loss and a validation loss for each of the plurality of training iterations; and
the mean absolute loss difference for the plurality of training iterations is determined based on an average of the training loss minus the validation loss for each of the plurality of training iterations.

19. The method according to claim 18 wherein:
the plurality of training iterations comprises a first set of training iterations and a second set of training iterations;
determining the mean absolute loss difference for the plurality of training iterations comprises:
determining a mean absolute loss difference for the first set of training iterations;
determining whether the mean absolute loss difference for the first set of training iterations is greater than a second threshold; and
determining whether the machine learning model has re-stabilised further comprises:
determining a mean absolute loss difference for the second set of training iterations;
calculating a standard deviation of: the mean absolute loss difference for the first set of training iterations and the mean absolute loss difference for the second set of training iterations;
determining whether the standard deviation is less than a third threshold; and
in response to determining that the standard deviation is less than the third threshold:
calculating a line of best fit between the mean absolute loss difference for the first set of training iterations and the mean absolute loss difference for the second set of training iterations; and
determining that the machine learning model has destabilised and destabilised recently if the gradient of the line of best fit is within a fourth threshold.

20. The method according to claim 15, further comprising training the machine learning model based on a training data set comprising the at least part of the data in response to receiving the at least part of the data.
